(19) United States
(12) Patent Application Publication
(10) Pub. No.: US 2019/0006698 A1
(43) Pub. Date: Jan. 3, 2019

(54) POWER STORAGE DEVICE AND MANUFACTURING METHOD THEREOF

(71) Applicant: Murata Manufacturing Co., Ltd., Nagaokakyo-shi (JP)

(72) Inventors: Toru Kawai, Nagaokakyo-shi (JP); Masahiro Otsuka, Nagaokakyo-shi (JP)

(21) Appl. No.: 16/124,314

(22) Filed: Sep. 7, 2018

Related U.S. Application Data
(63) Continuation of application No. PCT/JP2017/010648, filed on Mar. 16, 2017.

(30) Foreign Application Priority Data
Mar. 28, 2016 (JP) 2016-064722

(51) Int. Cl. H01M 10/04; H01G 11/26; H01G 11/52; H01G 11/86; H01G 11/78; H01G 11/70; H01G 11/62; H01M 2/16; H01M 10/0587

(52) U.S. Cl. CPC H01M 10/0431; H01G 11/26; H01G 11/52; H01G 11/86; H01M 10/0587; H01G 11/70; H01G 11/62; H01M 2/1673; H01G 11/78

(57) ABSTRACT

A power storage device that includes a first wound body which is formed by winding part of a stacked body including a positive electrode, a negative electrode and a separator disposed between the positive electrode and the negative electrode; and a second wound body which is formed by winding at least part of a portion of the stacked body which does not constitute the first wound body, and at least one of a length in a winding axis direction and a position in the winding axis direction of the second wound body is different from the first wound body.

### CROSS REFERENCE TO RELATED APPLICATIONS

The present application is a continuation of International application No. PCT/JP2017/010648, filed Mar. 16, 2017, which claims priority to Japanese Patent Application No. 2016-064722, filed Mar. 28, 2016, the entire contents of each of which are incorporated herein by reference.

### FIELD OF THE INVENTION

The present invention relates to a power storage device and a manufacturing method of the power storage device.

### BACKGROUND OF THE INVENTION

In recent years, electronic devices are increasingly becoming smaller and thinner. Hence, a restriction on a space for disposing a power storage device to be mounted on an electronic device is becoming strict. For example, there is a demand for disposing a power storage device in a space which does not have a rectangular parallelepiped shape. For example, Patent Literature 1 discloses a power storage device (battery assembly) which does not have a rectangular parallelepiped shape. The battery assembly disclosed in Patent Literature 1 has a shape which is not a rectangular shape in a side view.

Patent Document 1: Japanese Patent Application Laid-Open No. 2014-524131

### SUMMARY OF THE INVENTION

There is also a demand for a power storage device which does not have a rectangular shape in a plan view.

A main object of the present invention is to provide a low-cost power storage device which does not have a rectangular shape in a plan view from an upper surface of a case thereof.

A power storage device according to the present invention includes a first wound body and a second wound body. The first wound body is formed by winding part of a stacked body including a positive electrode, a negative electrode and a separator disposed between the positive electrode and the negative electrode. A second wound body is formed by winding at least part of a portion of the stacked body which does not constitute the first wound body. At least one of a length in a winding axis direction and a position in the winding axis direction of the second wound body is different from the first wound body.

In the power storage device according to the present invention, an electrode body is constituted by a winding type electrode body which can be made at low cost. Consequently, it is possible to provide a low-cost power storage device which does not have a rectangular shape in the plan view compared to, for example, a case where the electrode body which does not have the rectangular shape in the plan view and is made by laminating the electrode and the separator.

In the power storage device according to the present invention, a winding axis of the first wound body and a winding axis of the second wound body may be parallel to each other.

In the power storage device according to the present invention, a winding axis of the first wound body and a winding axis of the second wound body may be perpendicular to each other, or not parallel.

In the power storage device according to the present invention, a winding direction of the first wound body and a winding direction of the second wound body may be identical to each other.

In the power storage device according to the present invention, a winding direction of the first wound body and a winding direction of the second wound body may be opposite to each other.

In the power storage device according to the present invention, a number of turns of the first wound body and a number of turns of the second wound body may be identical to each other.

In the power storage device according to the present invention, a number of turns of the first wound body and a number of turns of the second wound body may be different from each other.

The manufacturing method of the power storage device according to the present invention includes preparing a stacked body including a positive electrode, a negative electrode and a separator disposed between the positive electrode and the negative electrode, forming the first wound body by winding part of the stacked body, and forming the second wound body by winding a second part of the stacked body that does not constitute the first wound body.

The present invention can provide a low-cost power storage device which does not have a rectangular shape in a plan view from an upper surface of the case thereof.

### BRIEF EXPLANATION OF THE DRAWINGS

FIG. 1 is a schematic perspective view of a power storage device according to a first embodiment.

FIG. 2 is a schematic perspective view of an electrode body according to the first embodiment.

FIG. 3 is a schematic plan view for explaining a method for manufacturing the electrode body according to the first embodiment.

FIG. 4 is a schematic perspective view of a power storage device according to a first modification of the first embodiment.

FIG. 5 is a schematic perspective view of a power storage device according to a second modification of the first embodiment.

FIG. 6 is a schematic perspective view of an electrode body according to a second embodiment.

FIG. 7 is a schematic plan view for explaining a method for manufacturing the electrode body according to the second embodiment.

FIG. 8 is a schematic perspective view of an electrode body according to a third embodiment.

FIG. 9 is a schematic plan view for explaining a method for manufacturing the electrode body according to the third embodiment.

FIG. 10 is a schematic perspective view of an electrode body according to a fourth embodiment.

FIG. 11 is a schematic plan view for explaining a method for manufacturing the electrode body according to the fourth embodiment.

FIG. 12 is a schematic perspective view of an electrode body according to a fifth embodiment.

FIG. 13 is a schematic perspective view of an electrode body according to a sixth embodiment.

FIG. 14 is a schematic plan view for explaining a method for manufacturing the electrode body according to the sixth embodiment.

### DETAILED DESCRIPTION OF THE INVENTION

Hereinafter, examples of preferred modes for carrying out the present invention will be described. In this regard, the following embodiments are merely exemplary embodiments. The present invention is by no means limited to the following embodiments.

Furthermore, members having substantially the same functions will be referred to based on the same reference numerals in each drawing of the various embodiments. Furthermore, the drawings referred to in the embodiments provide schematic illustrations. Ratios of dimensions of objects in the drawings are different from actual ratios of dimensions of these objects, and dimensional ratios of the objects are different between the drawings in some cases.

### First Embodiment

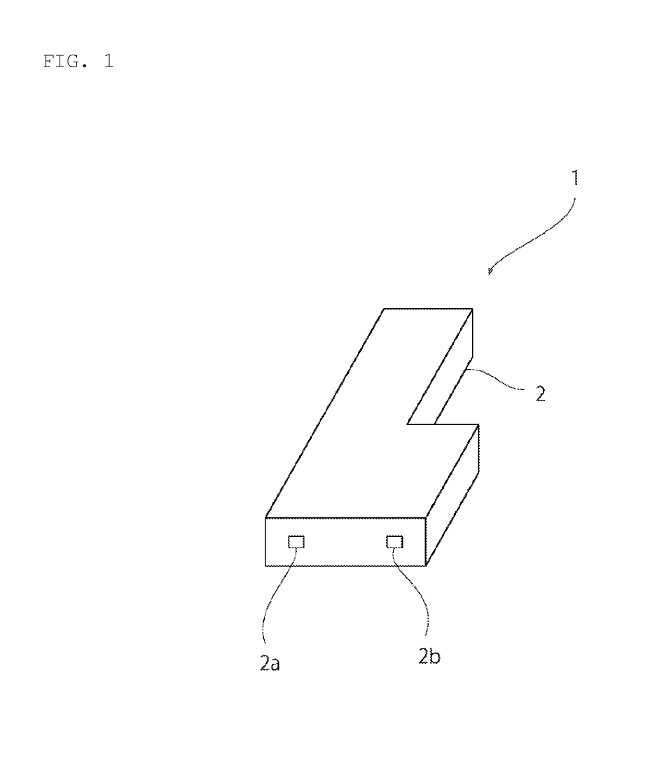

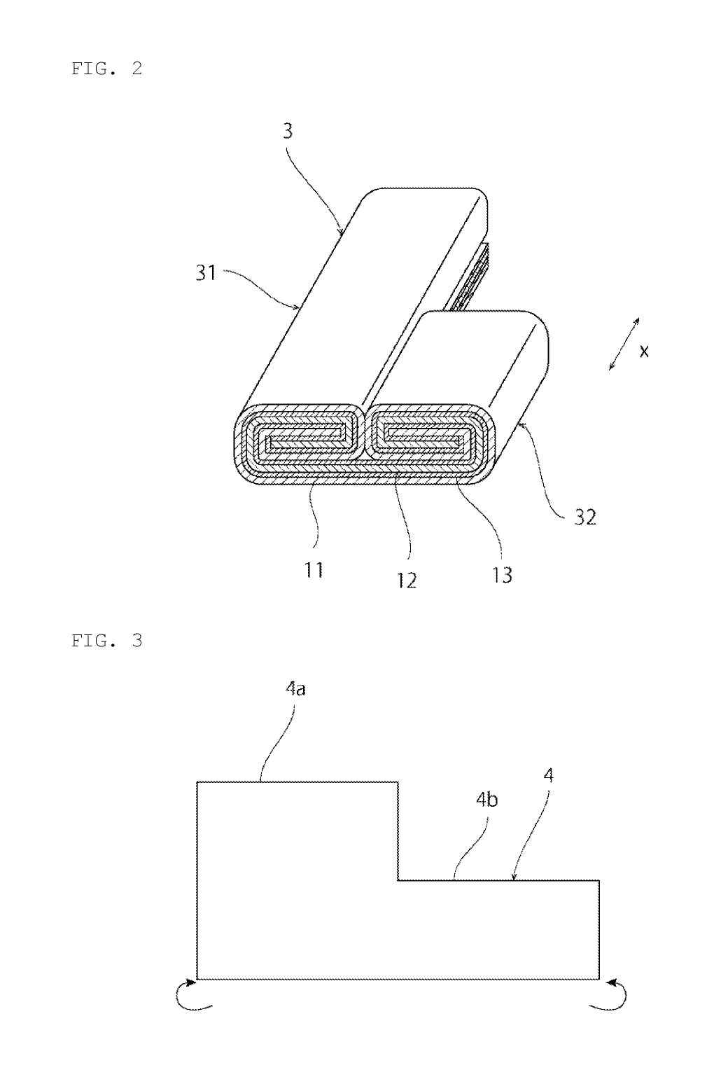

FIG. 1 is a schematic perspective view of a power storage device according to the first embodiment. FIG. 2 is a schematic perspective view of an electrode body according to the first embodiment.

A power storage device 1 illustrated in FIG. 1 may be, for example, a battery such as a secondary battery or a capacitor such as an electric double layer capacitor.

As illustrated in FIG. 1, the power storage device 1 includes a case 2. The case 2 has a shape which is that is not a rectangular shape in a plan view from the upper surface of the case 2. The shape of the case 2 in the plan view may be, for example, an L shape, an H shape, a U shape or a T shape. That is, according to the present invention, the case may have any shape as long as the shape in the plan view is not a rectangular shape.

The case 2 may be formed from a conductor or may be formed from an insulation body. The case 2 can be made of, for example, metal such as aluminum, stainless steel or copper or a resin such as a laminated film.

A first terminal 2a and a second terminal 2b are provided on one side surface of the case 2. One of the first terminal 2a and the second terminal 2b constitutes a positive electrode terminal, and the other one constitutes a negative electrode terminal. Both of the positive electrode terminal and the negative electrode terminal do not necessarily need to be provided. For example, only the positive electrode terminal may be provided, and the negative electrode terminal may be constituted by the case 2 formed of a conductor. The first terminal 2a and the second terminal 2b may be directly provided on a side surface of the case 2 or may be extended from the side surface of the case 2 by a tab.

An electrode body 3 illustrated in FIG. 2 is disposed inside the case 2. The shape of the electrode body 3 in the plan view follows the shape of the case 2 in the plan view. More specifically, in the present embodiment, both of the case 2 and the electrode body 3 are formed in an L shape. For example, when the case has an H shape, the electrode body is formed in the H shape. When the case has a U shape, the electrode body is formed in the U shape.

The electrode body 3 includes a positive electrode 11, a negative electrode 12 and a separator 13. The positive electrode 11 and the negative electrode 12 face each other with the separator 13 interposed therebetween. This separator 13 separates and insulates the positive electrode 11 and the negative electrode 12.

A configuration of the positive electrode 11 can be appropriately determined based on a type of the power storage device 1. When, for example, the power storage device 1 is a secondary battery, the positive electrode 11 can be constituted by a positive electrode current collector and an active material layer provided on at least one surface of the positive electrode current collector. When, for example, the power storage device 1 is an electric double layer capacitor, the positive electrode 11 can be constituted by a positive electrode current collector and a polarizable electrode layer provided on at least one surface of the positive electrode current collector.

A configuration of the negative electrode 12 can be appropriately determined based on the type of the power storage device 1. When, for example, the power storage device 1 is a secondary battery, the negative electrode 12 can be constituted by a negative electrode current collector and an active material layer provided on at least one surface of the negative electrode current collector. When, for example, the power storage device 1 is an electric double layer capacitor, the negative electrode 12 can be constituted by a negative electrode current collector and a polarizable electrode layer provided on at least one surface of the negative electrode current collector.

The separator 13 can be constituted by, for example, a porous sheet having continuous holes in which ions in an electrolyte are movable. The separator 13 may be made of, for example, polypropylene, polyethylene, polyimide, cellulose, aramid, polyvinylidene fluoride or Teflon (registered trademark). Furthermore, a surface of the separator 13 may be covered by a ceramic coating layer or an adhesive layer. The surface of the separator 13 may have adhesiveness. Furthermore, a separator 13 may be a single layer film made of a material of one type, or a composite film or a multilayer film made of materials one or two or more types.

Furthermore, the separator 13 may not be provided, or the separator 13 may be provided and an insulation layer such as a ceramic coating layer may be provided on surfaces of the positive electrode 11 and the negative electrode 12.

In addition, an undercoat layer including carbon may be provided between the current collector of the positive electrode 11 and the negative electrode 12 and the active material layer.

The separator 13 is impregnated with an electrolyte. The electrolyte includes a solute and a solvent. The solute to be used is preferably Li salt such as LiPF₆ or LiBF₄ when, for example, the power storage device 1 is the secondary battery. When, for example, the power storage device 1 is a secondary battery, the solvent to be used is preferably an organic solvent such as ethylene carbonate (EC), propylene carbonate (PC), dimethyl carbonate (DMC), ethyl methyl carbonate (EMC) or diethyl carbonate (DEC). The electrolyte may be a liquid or a polymeric electrolyte may be used.

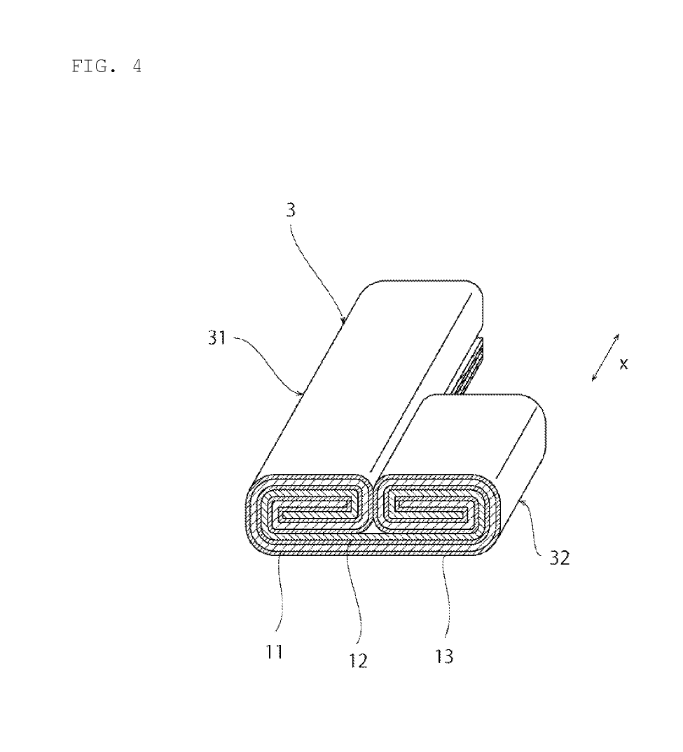

As illustrated in FIG. 2, in the present embodiment, the electrode body 3 has an L shape in the plan view. More specifically, the electrode body 3 includes a first wound body 31 which is formed by winding, about an x axis direction as a center axis, part of a stacked body 4 (see FIG. 3) formed by laminating the positive electrode 11, the separator 13, the negative electrode 12 and the separator 13 in this order, and a second wound body 32 which is formed by winding, about the x axis direction as the center axis, at least part of a portion of the stacked body 4 which does not constitute the first wound body 31. Hence, an extension direction of a winding axis of the first wound body 31 and an extension direction of a winding axis of the second wound body 32 are parallel. In the present embodiment, the length in the extension direction (x axis direction) of the winding axis of the first wound body 31 and the length in the extension direction (x axis direction) of the winding axis of the second wound body 32 are different. More specifically, the length in the extension direction (x axis direction) of the winding axis of the first wound body 31 is longer than the length in the extension direction (x axis direction) of the winding axis of the second wound body 32. Hence, the integrally formed first wound body 31 and second wound body 32 constitute the electrode body 3 having the substantially L shape in the plan view.

Next, an example of a manufacturing method of the power storage device 1 will be described. First, a positive electrode, a negative electrode and a separator are prepared. More specifically, a positive electrode slurry including the positive electrode active material is coated on at least one surface of the positive electrode current collector, and is dried to make the positive electrode. Similarly, a negative electrode slurry including the negative electrode active material is coated on at least one surface of the negative electrode active material, and is dried to make the negative electrode. Next, the positive electrode, the separator, the negative electrode and the separator are laminated in this order to make the stacked body 4 illustrated in FIG. 3.

As illustrated in FIG. 3, the length along the x axis direction of a portion 4a of the stacked body 4 which constitutes the first wound body 31 is longer than the length along the x axis direction of a portion 4b which constitutes the second wound body 32. The portion 4a of this stacked body 4 is wound along a first rotation direction, and the portion 4 is wound along a second rotation direction which is a direction opposite to the first rotation direction to make the electrode body 3 including the first and second wound bodies 31 and 32 whose horizontal cross sections are substantially rectangular shapes. In addition, a separator which covers an outer circumference of the electrode body 3 may be further provided.

Next, by housing the electrode body 3 in the case 2 (see FIG. 1) and filling the electrolyte therein, it is possible to finish the power storage device 1.

By the way, when an electrode body is constituted by a wound body of a stacked body including a positive electrode, a separator and a negative electrode (hereinafter “the wound body of the stacked body including the positive electrode, the separator and the negative electrode” will be referred to as an “electrode wound body”), the electrode wound body has a columnar shape or a substantially rectangular parallelepiped shape. Therefore, when the electrode body is constituted by one electrode wound body, it is difficult to constitute a power storage device which does not have a rectangular shape in the plan view.

A method for realizing the power storage device which does not have a rectangular shape in the plan view includes using a lamination-type electrode body which does not have a rectangular shape and is formed by laminating a positive electrode, a separator and a negative electrode in order. However, the lamination-type electrode body has a complicated manufacturing process, and has high manufacturing cost. Hence, it is difficult to obtain low-cost power storage devices.

On the other hand, in the present embodiment, the electrode body 3 is constituted by a plurality of wound bodies 31 and 32. The electrode body 3 constituted by a plurality of wound bodies 31 and 32 can be more easily manufactured at lower cost than the lamination-type electrode body. Hence, the power storage device 1 according to the present embodiment is low cost even when the shape in the plan view is not a rectangular shape.

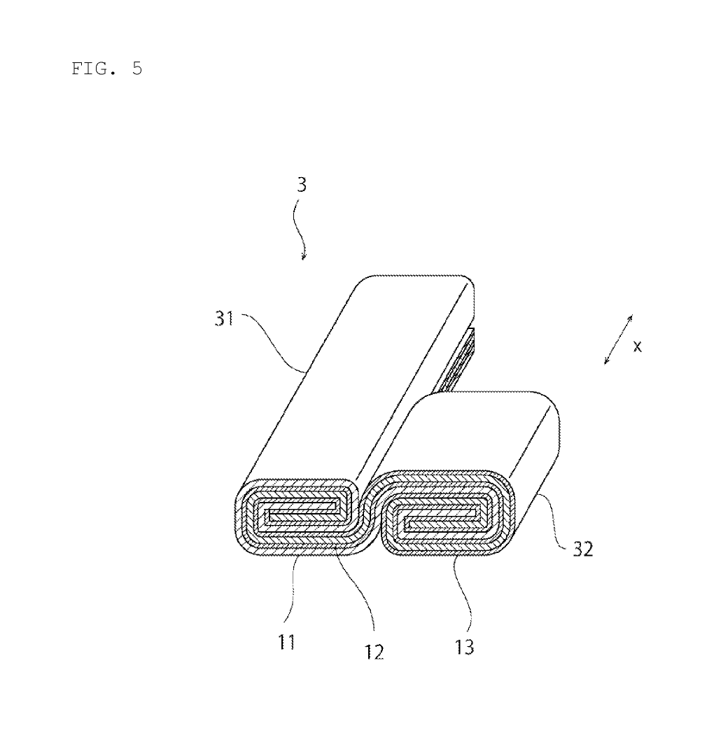

In addition, in the present embodiment, the stacked body 4 formed by laminating the positive electrode 11, the separator 13, the negative electrode 12 and the separator 13 in this order is used. However, the present invention is not limited to this configuration. As illustrated in, for example, FIG. 4, the separator 13, the positive electrode 11, the separator 13 and the negative electrode 12 may be laminated in this order.

The present embodiment has described the example where the winding direction of the first wound body 31 and the winding direction of the second wound body 32 are opposite directions. By so doing, the entire outer surface of the electrode body 3 is constituted by the positive electrode 11 covered by the separator 13. Consequently, it is possible to prevent occurrence of a short-circuiting failure caused when the electrode body 3 and the case 2 contact.

Furthermore, the present embodiment has described the example where the winding direction of the first wound body 31 and the winding direction of the second wound body 32 are the same.

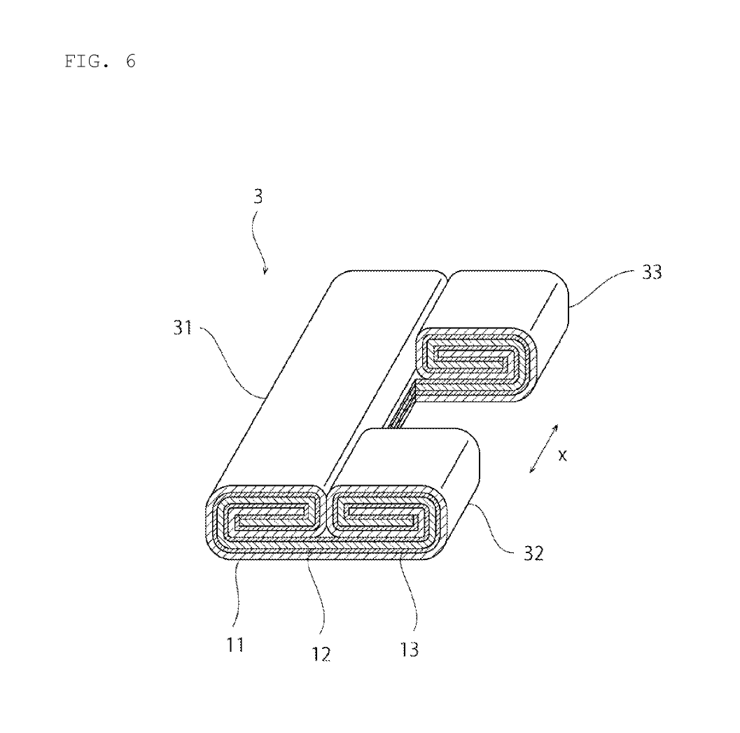

However, the present invention is not limited to this configuration. As illustrated in, for example, FIG. 5, the winding direction of the first wound body 31 and the winding direction of the second wound body 32 may be the same. By so doing, it is possible to increase an area in which the positive electrode 11 and the negative electrode 12 face each other in a boundary portion of the first wound body 31 and the second wound body 32. Consequently, it is possible to enhance an energy density of the power storage device 1.

In the present embodiment, the number of turns of the first wound body 31 and the number of turns of the second wound body 32 are the same. Consequently, it is possible to obtain the electrode body 3 which has little unevenness in thickness. In this regard, according to the present invention, the number of turns of the first wound body and the number of turns of the second wound body may be different.

In the present embodiment, the winding axis of the first wound body and the winding axis of the second wound body are parallel. However, the present invention is not limited to this configuration. For example, the winding axis of the first wound body and the winding axis of the second wound body may be substantially perpendicular. In the other words, an angle formed between the winding axis of the first wound body and the winding axis of the second wound body may be approximately 90°.

Other examples of the preferred embodiments of the present invention will be described below. Members having substantially common functions to those of the first embodiment will be referred to based on common reference numerals below, and description thereof will be omitted.

### Second Embodiment

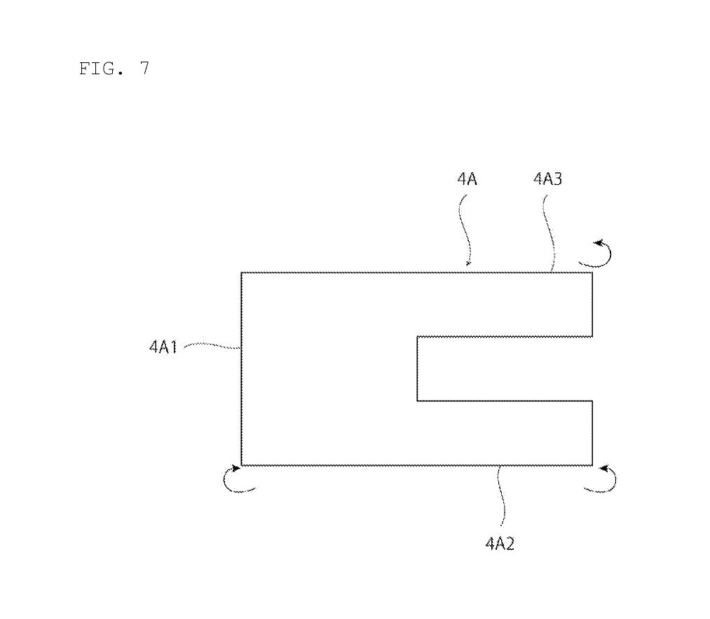

FIG. 6 is a schematic perspective view of an electrode body according to a second embodiment.

As illustrated in FIG. 6, in the second embodiment, the electrode body 3 includes the first wound body 31, the second wound body 32 and a third wound body 33. While the second wound body 32 is connected to one side end portion in the winding axis direction (x axis direction) of the first wound body 31, the third wound body 33 is connected to another side end portion in the winding axis direction (x axis direction) of the first wound body 31. Hence, the electrode body 3 has a U shape in the plan view. By using the electrode body 3 according to the present embodiment, it is possible to realize the power storage device which has the substantially U shape in the plan view.

In addition, the electrode body 3 according to the present embodiment can be made by, for example, using a stacked body 4A illustrated in FIG. 7. The stacked body 4A includes a first portion 4A1 which extends in the x axis direction, a second portion 4A2 which extends from one side end portion in the x axis direction of the first portion 4A1 toward a y axis direction perpendicular to the x axis direction, and a third portion 4A3 which extends from the other side end portion in the x axis direction of the first portion 4A1 toward the y axis direction. By appropriately winding and pressing the first to third portions 4A1, 4A2 and 4A3 of this stacked body 4A, it is possible to make the electrode body 3 according to the present embodiment.

### Third Embodiment

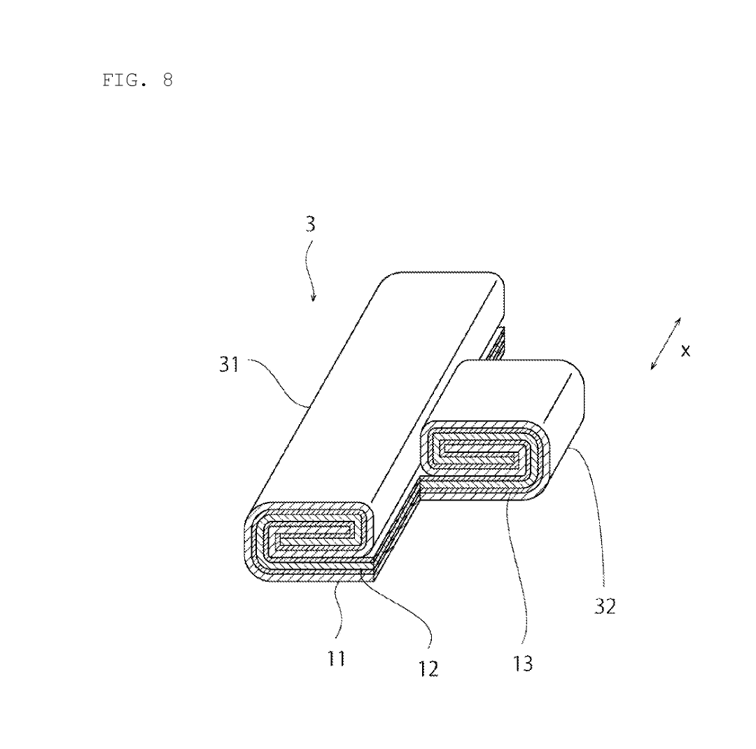

FIG. 8 is a schematic perspective view of an electrode body according to a third embodiment.

As illustrated in FIG. 8, in the third embodiment, the electrode body 3 includes the first wound body 31 and the second wound body 32. The second wound body 32 is connected to a center portion in the winding axis direction (x axis direction) of the first wound body 31. Hence, the electrode body 3 has a substantially T shape in the plan view. By using the electrode body 3 according to the present embodiment, it is possible to realize the power storage device which has the substantially T shape in the plan view.

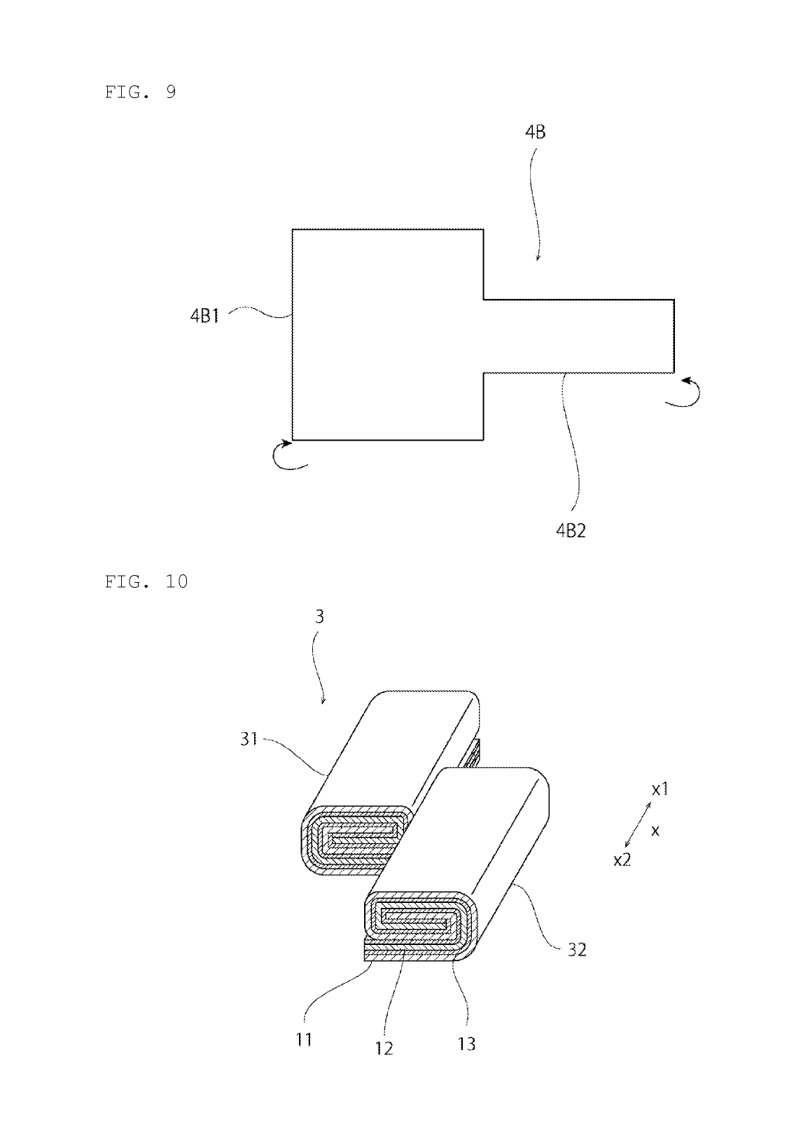

In addition, the electrode body 3 according to the present embodiment can be made by, for example, using a stacked body 4B illustrated in FIG. 9. The stacked body 4B includes a first portion 4B1 which extends in the x axis direction, and a second portion 4B2 which extends from a center portion in the x axis direction of the first portion 4B1 toward the y axis direction perpendicular to the x axis direction. By appropriately winding the first and second portions 4B1 and 4B2 of this stacked body 4B, it is possible to make the electrode body 3 according to the present embodiment.

### Fourth Embodiment

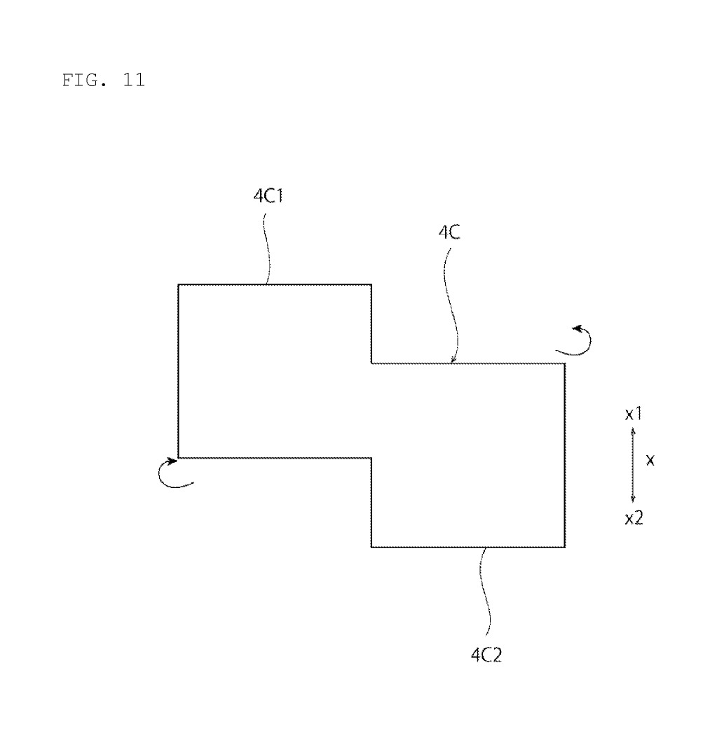

FIG. 10 is a schematic perspective view of an electrode body according to a fourth embodiment.

As illustrated in FIG. 10, in the fourth embodiment, the electrode body 3 includes the first wound body 31 and the second wound body 32. The first wound body 31 is located closer to an x1 side in the x axis direction than the second wound body 32, and the second wound body 32 is located closer to an x2 side in the x axis direction than the first wound body 31. Hence, the electrode body 3 according to the present embodiment has a stepwise shape. By using the electrode body 3 according to the present embodiment, it is possible to realize the power storage device which has the stepwise shape in the plan view.

In addition, the electrode body 3 according to the present embodiment can be made by, for example, using a stacked body 4C illustrated in FIG. 11. The stacked body 4C includes a first portion 4C1 which extends in the x axis direction, and a second portion 4C2 which extends in the x axis direction and is located closer to the x2 side than the first portion 4C1. By appropriately winding the first and second portions 4C1 and 4C2 of this stacked body 4C, it is possible to make the electrode body 3 according to the present embodiment.

By differing a position in the winding axis direction of the first wound body and a position in the winding axis direction of the second wound body as in the present embodiment, it is possible to make the electrode body 4 which does not have a rectangular shape in the plan view. When position in the winding axis direction of the first wound body and the position in the winding axis direction of the second wound body differ, and even when the length in the winding direction of the first wound body and the length in the second winding direction are the same, it is possible to make the electrode body which does not have the rectangular shape in the plan view.

### Fifth Embodiment

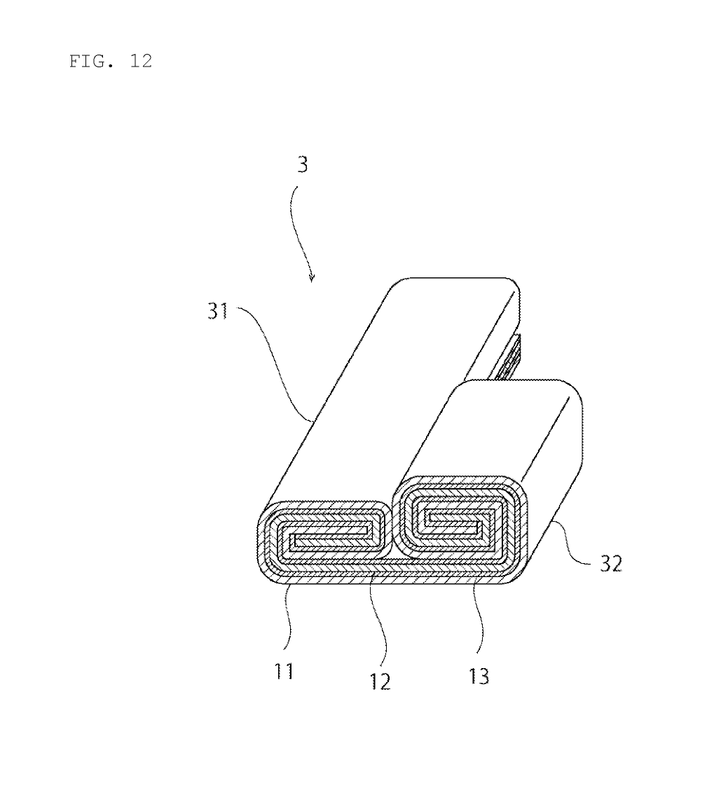

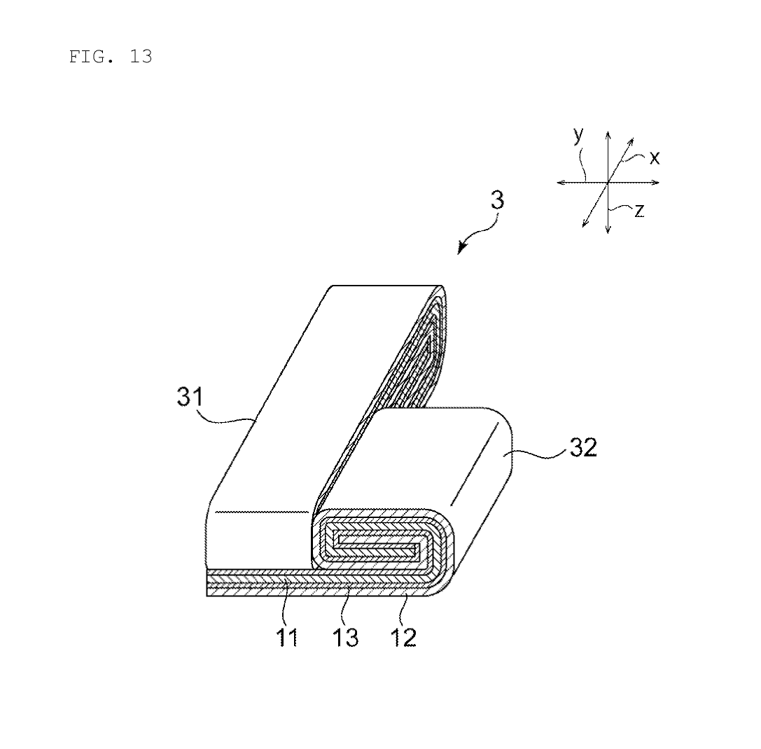

FIG. 12 is a schematic perspective view of an electrode body according to a fifth embodiment.

The electrode body according to the present embodiment differs from the electrode body according to the first embodiment in that the number of turns of the first wound body 31 and the number of turns of the second wound body 32 are different. The electrode body 3 according to the present embodiment does not have a rectangular shape in the plan view, and has a difference in height in a height direction. Consequently, by using the electrode body 3 according to the present embodiment, it is possible to realize a power storage device which does not have the rectangular shape in the plan view and has the difference in height in the height direction.

### Sixth Embodiment

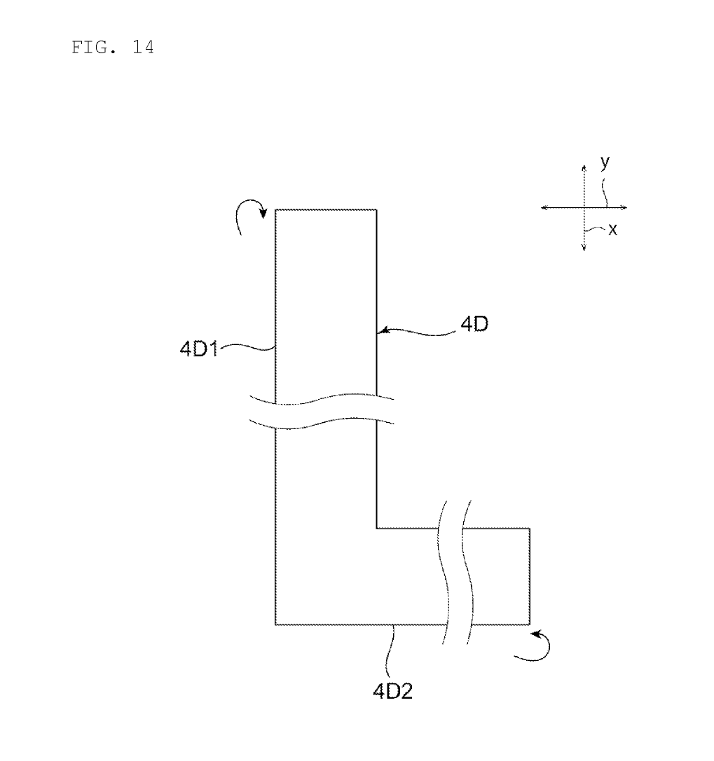

FIG. 13 is a schematic perspective view of an electrode body according to a sixth embodiment.

The first to sixth embodiments have described the examples where the extension directions of the respective winding axes of a plurality of wound bodies included in the electrode body 3 are parallel. However, the present invention is not limited to this configuration. For example, a plurality of wound bodies included in the electrode body may include a wound body whose extension direction of the winding axis is substantially perpendicular. FIG. 13 illustrates an example of this electrode body.

As illustrated in FIG. 13, in the electrode body 3 according to the sixth embodiment, the winding axis of the first wound body 31 extends in the y axis direction perpendicular to the x axis direction. On the other hand, the winding axis of the second wound body 32 extends in the x axis direction.

The electrode body 3 illustrated in FIG. 13 can be manufactured as follows, for example. First, a stacked body 4D (see FIG. 14) having the L shape in the plan view is prepared. Next, by appropriately winding a first portion 4D1 which extends in the x axis direction of the stacked body 4D such that the winding axis lies in the y axis direction, and appropriately winding a second portion 4D2 which extends in the y axis direction of the stacked body 4D such that the winding axis lies in the x axis direction, so that it is possible to make the electrode body 3 according to the present embodiment.

### DESCRIPTION OF REFERENCE SYMBOLS

1: POWER STORAGE DEVICE
2: CASE
2a: FIRST TERMINAL
2b: SECOND TERMINAL
3: ELECTRODE BODY
4, 4A, 4B, 4C, 4D: STACKED BODY
11: POSITIVE ELECTRODE
12: NEGATIVE ELECTRODE
13: SEPARATOR
31: FIRST WOUND BODY
32: SECOND WOUND BODY
33: THIRD WOUND BODY

1. A power storage device comprising:
a first wound body which is formed by winding part of a stacked body including a positive electrode, a negative electrode and a separator disposed between the positive electrode and the negative electrode, the stacked body including:
a first wound body containing the positive electrode, the negative electrode and the separator; and
a second wound body containing the positive electrode, the negative electrode and the separator and is a portion of the stacked body that does not constitute the first wound body,
wherein at least one of a length in a winding axis direction and/or a position in the winding axis direction of the second wound body is different from the first wound body.

2. The power storage device according to claim 1, wherein a first winding axis of the first wound body and a second winding axis of the second wound body are parallel to each other.

3. The power storage device according to claim 2, wherein a first winding direction of the first wound body and a second winding direction of the second wound body are identical to each other.

4. The power storage device according to claim 2, wherein a first winding direction of the first wound body and a second winding direction of the second wound body are opposite to each other.

5. The power storage device according to claim 1, wherein a first winding axis of the first wound body and a second winding axis of the second wound body are not parallel to each other.

6. The power storage device according to claim 1, wherein a first winding direction of the first wound body and a second winding direction of the second wound body are identical to each other.

7. The power storage device according to claim 1, wherein a first winding direction of the first wound body and a second winding direction of the second wound body are opposite to each other.

8. The power storage device according to claim 1, wherein a first number of turns of the first wound body and a second number of turns of the second wound body are identical to each other.

9. The power storage device according to claim 1, wherein a first number of turns of the first wound body and a second number of turns of the second wound body are different from each other.

10. The power storage device according to claim 1, wherein the stacked body further includes:
a third wound body containing the positive electrode, the negative electrode and the separator and is a portion of the stacked body that does not constitute the first wound body or the second wound body.

11. A method for manufacturing a power storage device, the method comprising:
preparing a stacked body including a positive electrode, a negative electrode and a separator disposed between the positive electrode and the negative electrode;
forming a first wound body by winding a first part of the stacked body; and
forming a second wound body by winding a second part of the stacked body that does not constitute the first wound body.

12. The method for manufacturing the power storage device according to claim 11, wherein a first winding axis of the first wound body and a second winding axis of the second wound body are parallel to each other.

13. The method for manufacturing the power storage device according to claim 12, wherein a first winding direction of the first wound body and a second winding direction of the second wound body are identical to each other.

14. The method for manufacturing the power storage device according to claim 12, wherein a first winding direction of the first wound body and a second winding direction of the second wound body are opposite to each other.

15. The method for manufacturing the power storage device according to claim 11, wherein a first winding axis of the first wound body and a second winding axis of the second wound body are not parallel to each other.

16. The method for manufacturing the power storage device according to claim 11, wherein a first winding direction of the first wound body and a second winding direction of the second wound body are identical to each other.

17. The method for manufacturing the power storage device according to claim 11, wherein a first winding direction of the first wound body and a second winding direction of the second wound body are opposite to each other.

18. The method for manufacturing the power storage device according to claim 11, wherein a first number of turns of the first wound body and a second number of turns of the second wound body are identical to each other.

19. The method for manufacturing the power storage device according to claim 11, wherein a first number of turns of the first wound body and a second number of turns of the second wound body are different from each other.

20. The method for manufacturing the power storage device according to claim 11, further comprising:
forming a third wound body by winding a third part of the stacked body that does not constitute the first wound body or the second wound body.
